(19) United States
(12) Patent Application Publication
(10) Pub. No.: US 2008/0120132 A1
(43) Pub. Date: May 22, 2008

(54) Dynamic Tag Display System and Method

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/562,564

(22) Filed: Nov. 22, 2006

(51) Int. Cl. G06Q 10/00; G06Q 50/00

(52) U.S. Cl. 705/2

(57) ABSTRACT

A dynamic tag display system and method for dynamically changing the presentation of at least one patient demographic by changing from a first presentation mode to a second presentation mode for that at least one patient demographic, if a condition is met and also for dynamically indicating a measurement value and associated patient diagnosis information within an image. First, an image markup is created using a measurement tool. Then a measurement value associated with the image markup is determined and displayed. If the measurement value meets a condition indicating a pathology then patient diagnosis information is displayed.

### FIELD

The embodiments described herein relate to dynamic image viewing systems and methods and more particularly to a system and method for dynamically changing the presentation of a displayed patient demographic and measurement value associated with a displayed image as well as providing patient diagnosis information related to a displayed image.

### BACKGROUND

Commercially available image display systems in the medical field utilize various techniques to present image data to a user. Specifically, image data produced within modalities such as Computed Tomography (CT), Magnetic Resonance (MR) and the like is displayed on a display terminal for review by a medical practitioner at a medical treatment site. This image data is used by the medical practitioner to determine the presence or absence of a disease or pathology.

Many attempts to optimize the presentation of the image to the medical practitioner have been made. For example, using electronic measurement tools, the medical practitioner has the ability to create image markups on a displayed image. Medical systems utilize those image markups to calculate the measurement value associated with a displayed image component, such as for example the length of an image component.

A medical practitioner can use the calculated measurement value to make a diagnosis. Accordingly, a system and method that utilizes the calculated measurement value to determine whether a specified pathology is potentially present in the displayed image, that is to make a “smart diagnosis”, is highly desirable. Patient demographics, namely a set of textual attributes that describe an image can be displayed to a medical practitioner to assist in making a diagnosis, since patient demographics may be relevant to the diagnosis. Examples of patient demographics are the patient's age and the displayed image zoom ratio.

### SUMMARY

The embodiments described herein provide in one aspect, a system for dynamically changing the presentation of at least one patient demographic by changing from a first presentation mode to a second presentation mode for that at least one patient demographic, said system comprising:
(a) a memory for storing the at least one patient demographic, a first presentation state, a second presentation state and a condition;
(b) a processor coupled to the memory and configured for:
   i. displaying the at least one patient demographic in the first presentation mode;
   ii. determining if the displayed at least one patient demographic meets a condition; and
   iii. If (ii) is true, then changing from the first presentation mode to the second presentation mode for that at least one patient demographic.

The embodiments described herein provide in another aspect, a system for dynamically indicating a measurement value and associated patient diagnosis information within an image, said system comprising:
(a) a memory for storing image data associated with the image, patient diagnosis information and a condition;
(b) a processor coupled to the memory and configured for:
   i. creating an image markup by marking up the image using a measurement tool;
   ii. determining a measurement value for the image markup;
   iii. displaying the measurement value determined in (ii);
   iv. determining whether the measurement value meets a condition indicating a pathology; and
   v. If (iv) is true, then displaying the patient diagnosis information associated with the pathology indicated in (iv).

The embodiments described herein provide in another aspect, a method for dynamically changing the presentation of at least one patient demographic by changing from a first presentation mode to a second presentation mode for that at least one patient demographic, said method comprising:
(a) displaying the at least one patient demographic in the first presentation mode;
(b) determining if the displayed at least one patient demographic meets a condition; and
(c) If (b) is true, then changing from the first presentation mode to the second presentation mode for that at least one patient demographic.

The embodiments described herein provide in another aspect, a method for dynamically indicating a measurement value and associated patient diagnosis information within an image, said method comprising:
(a) creating an image markup by marking up the image using a measurement tool;
(b) determining a measurement value for the image markup;
(c) displaying the measurement value determined in (b);
(d) determining whether the measurement value meets a condition indicating a pathology; and
(e) If (d) is true, then displaying the patient diagnosis information associated with the pathology indicated in (d).

Further aspects and advantages of the embodiments described will appear from the following description taken together with the accompanying drawings.

### BRIEF DESCRIPTION OF THE DRAWINGS

For a better understanding of the embodiments described herein, and to show more clearly how it may be carried into effect, reference will now be made, by way of example only, to the accompanying drawings which at least one exemplary embodiment is described, and in which:

FIG. 1 is a block diagram of an exemplary embodiment of a dynamic tag display system;

FIG. 2 is a schematic diagram illustrating an example user interface generated by the dynamic tag display system of FIG. 1;

FIG. 3 is a flowchart diagram illustrating the main operational steps executed by the dynamic tag display system of FIG. 1 for changing the presentation mode of a displayed patient demographic;

FIG. 4 is a flowchart diagram illustrating the main operational steps executed by the dynamic tag display system of FIG. 1 for displaying patient diagnosis information;

FIG. 5 is a flowchart diagram illustrating the main operational steps executed by the dynamic tag display system of FIG. 1 for changing the presentation mode of a displayed measurement value;

FIG. 6 is a flowchart diagram illustrating the main operational steps executed by the dynamic tag display system of FIG. 1 in determining whether a measurement value indicates a specified pathology;

FIG. 7 is a schematic diagram illustrating one exemplary embodiment of a condition associated with the presentation mode of a patient demographic;

FIG. 8 is a schematic diagram illustrating one exemplary embodiment of a condition associated with the presentation mode of a measurement value; and

FIG. 9 is a schematic diagram illustrating one exemplary embodiment of a condition associated with a pathology and related patient diagnosis information.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

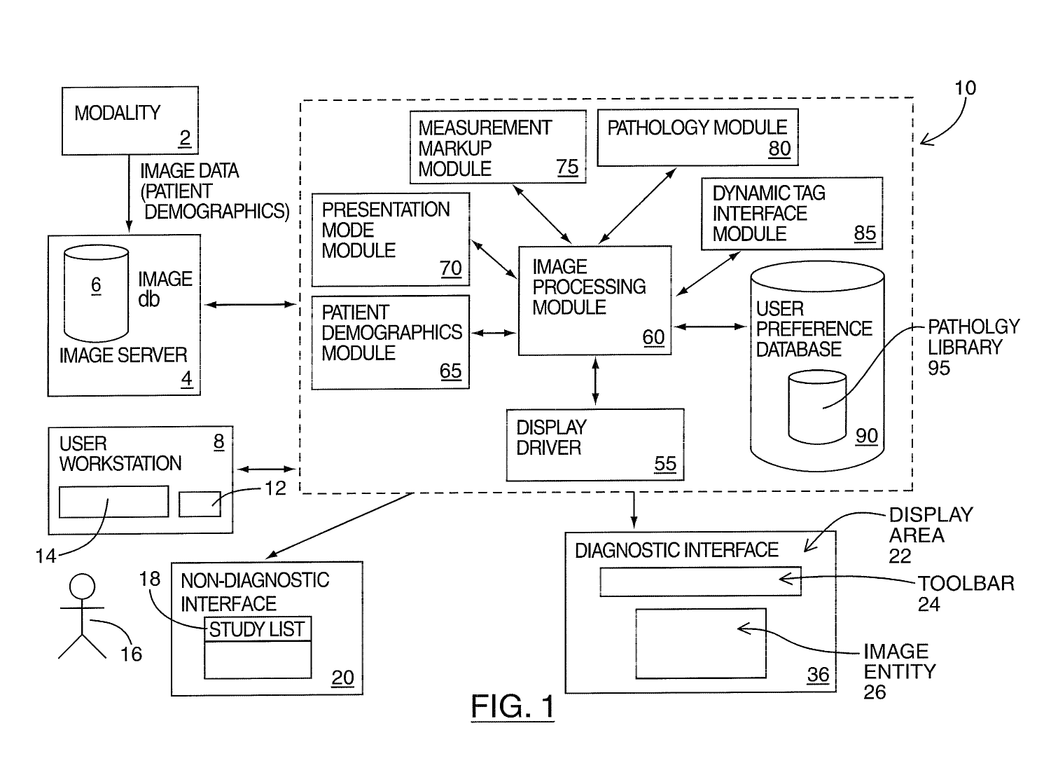

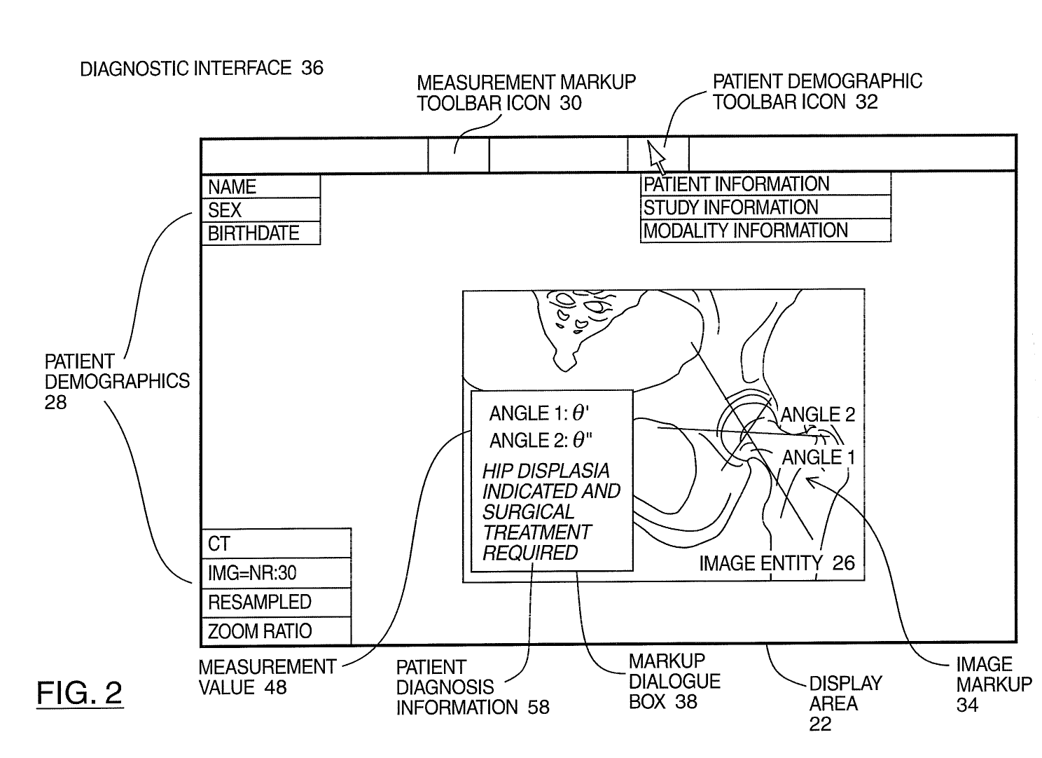

Reference is first made to FIGS. 1 and 2, which illustrate an exemplary embodiment of a dynamic tag display system. Specifically, FIG. 1 is a block diagram that illustrates how dynamic tag display system 10 includes a display driver 55, an image processing module 60, a patient demographics module 65, a presentation mode module 70, a measurement markup module 75, a pathology module 80, a dynamic tag interface module 85, and a user preference database 90 containing a pathology library 95. FIG. 2 is a schematic diagram that illustrates one exemplary embodiment of the graphical user interface generated by the dynamic tag interface module 85 of the dynamic tag display system 10.

As shown, image data (which includes patient demographics 28 as will be explained further) associated with one or more image entities 26 is generated by a modality 2 and stored in an image database 6 on an image server 4 for retrieval and display on a diagnostic interface 36. Image entities 26 can be in various forms including image studies, image series, or individual images. In addition, it should be understood that one or more image studies, image series, or individual images are typically associated with a particular patient. An index of image entities 26 (i.e., study list 18) is displayed on a non-diagnostic interface 20.

As discussed in more detail above, it should be understood that dynamic tag display system 10 may be implemented in hardware or software or a combination of both. Specifically, the modules of dynamic tag display system 10 are preferably implemented in computer programs executing on programmable computers each comprising at least one processor, a data storage system and at least one input and at least one output device. Without limitation the programmable computers may be a mainframe computer, server, personal computer, laptop, personal data assistant or cellular telephone. In some embodiments, dynamic tag display system 10 is implemented in software and installed on the hard drive of user workstation 8 and on image server 4, such that user workstation 8 interoperates with image server 4 in a client-server configuration. In other embodiments, the dynamic tag display system 10 can run from a single dedicated workstation that may be associated directly with a particular modality 2. In yet other embodiments, the dynamic tag display system 10 can be configured to run remotely on the user workstation 8 while communication with the image server 4 occurs via a wide area network (WAN), such as through the Internet.

Modality 2 is any conventional image data-generating device (e.g. computed tomography (CT) scanners, etc.) utilized to generate image data and patient demographics 28 that correspond to patient medical exams. A medical practitioner utilizes the image data generated by modality 2 to make a medical diagnosis (e.g. for investigating the presence or absence of a diseased part or injury or for ascertaining the characteristics of the diseased part of the injury). Modalities may be positioned in a single location or facility, such as a medical facility, or may be remote from one another. Image data from modality 2 are stored within an image database 6 within an image server 4 as conventionally known. Modality 2 provides image data to the image server 4 in analog or any digital format used to represent medical image data (e.g. DICOM, bitmaps, JPEGs, GIFs, etc.). The image server 4 then converts the image data into a digital format (i.e. a data file) suitable for storage within the image database 6 on the image server 4.

User workstation 8 includes a keyboard 14 and a user 16-pointing device (e.g. mouse 12) as shown in FIG. 1. It should be understood that user workstation 8 can be implemented to any wired or wireless computing device with input and display means (e.g. conventional personal computer, laptop computing device, personal digital assistant, etc.). User workstation 8 is operatively connected to non-diagnostic interface 20 and diagnostic interface 36. As discussed, in an exemplary embodiment, the module of dynamic tag display system 10 are preferably installed on the hard drive of the user workstation 8 and/or on image server 4 such that user workstation 8 interoperates with central image server 4 in a client server configuration.

Non-diagnostic interface 20 displays a study list 18 that provides the textual format listing of image entities 18 that are available for display. Study list 18 also includes associated identifying indicia (e.g. body part, modality, etc.) and organizes studies in current and prior image study categories. Other associated textual information (e.g. patient information image resolution quality, date of image capture, etc.) is simultaneously displayed within study list 18 to assist the user 16 in the selection of image entities 26.

Typically, user 16 will retrieve study list 18 and select listed image entities 26 for display on diagnostic interface 36. In this discussion, it should be understood that the term “image study” as used in the present disclosure covers all different image types (e.g. image series, image studies, individual images, etc.) without exclusion. Non-diagnostic interface 20 is preferably implemented using a conventional color computer monitor (e.g. a color monitor with a resolution of 1024×768) with sufficient processing power to run a conventional operating system (e.g. Windows NT). High-resolution graphics are not necessary to run this display since this display is only displaying textual information to the user 16.

Diagnostic interface 36 provides a high-resolution image display of image entities 26 (e.g. studies) to user 16 on display area 22 As shown in FIG. 2 images are displayed within the diagnostic interface 36 along with the dynamic tag interface toolbar 24. Diagnostic interface 36 is preferably provided using medical image quality display monitors with relatively high resolution typically used for reviewing CT and MR studies (e.g. grayscale “reading” monitors with a resolution of 1280-1024 and up). It should be understood that many other types of display configurations could be utilized within dynamic tag display system 10 including the use of one, two or more displays.

In one exemplary embodiment of dynamic tag display system 10, the user 16 selects an image entity 26 from the study list 18 for display on the diagnostic interface 36. It should be understood that the functionality of dynamic tag display system 10 is equally applicable to the display and arrangement of any image entity 26, such as image studies, image series, individuals images and the like.

Patient demographics module 65 retrieves image data associated with the image entity 26 selected for viewing and provides it to the image processing module 60. Image data contains image information that can be expressed as two logical parts. One part is known as pixel data and represents the displayed image. The other part will be referred to as patient demographics 28 and represents a set of textual attributes that describes the image.

It should be understood that patient demographics 28 can include study and image level attributes including, but not limited to, attributes such as patient-related information, image study-related information, modality-related information and image attributes. In addition, it should be understood that the term patient demographics 28 (FIG. 2) can refer to image characteristics calculated from various image attributes and patient demographics 28, including, but not limited to, the zoom ratio of the displayed image. It is apparent to those skilled in the art how the zoom ratio is calculated from image attributes. It should be understood that the term patient demographics 28 also include image attributes and patient demographics 28 that have undergone simple transformations as configured by the user 16. As such, image data associated with an image entity 26 includes corresponding patient demographics 28.

Image processing module 60 coordinates the activities of patient demographics module 65, presentation mode module 70, measurement markup module 75, pathology module 80, dynamic tag interface module 85, and user preference database 90 in response to commands sent by user 16 from user workstation 8. When user 16 launches an image entity 26 from study list 18 on non-diagnostic interface 20, image processing module 60 instructs patient demographics module 65 to retrieve image data, including patient demographics 28 (FIG. 2), that correspond to the selected image and to provide the image data to dynamic tag interface module 85.

Also, image processing module 60 instructs dynamic tag interface module 85 to generate a dynamic tag interface with a toolbar 24 (FIG. 1) containing measurement markup toolbar icon 30 and patient demographic toolbar icon 32 (FIG. 2). Image processing module 60 displays the selected image and the dynamic tag interface within display area 22 on diagnostic interface 36 using the display driver 55. Image processing module 60 controls the dynamic display of patient demographics 28 in response to presentation mode module 70 and commands sent by user 16 using mouse 12 (or keyboard 14) and patient demographic toolbar icon 32.

Finally, image processing module 60 retrieves an image markup 34 (FIG. 2) created by user 16 and provides it to measurement markup module 75 to determine the value of the markup in relation to the displayed image, i.e.: the measurement value 48 (FIG. 1). For example, a line image markup will have an associated measurement value 48, namely the length of the line image markup. Image processing module 60 also provides the pathology module 80 with a measurement value 48 and the patient demographics 28 to determine whether a pathology may be indicated. Image processing module 60 dynamically displays the measurement value 48 and the patient diagnosis information 58 associated with the indicated pathology on the diagnostic interface 36 through the display driver 55.

Dynamic tag interface module 85 generates a dynamic tag interface (i.e. a graphical user interface) having a toolbar 24 containing dynamic tag toolbar indicia including a measurement markup toolbar icon 30 and a patient demographic toolbar icon 32 (FIG. 2).

As previously mentioned, display area 22 contains a toolbar 24 generated by dynamic tag interface module 85 containing dynamic tag toolbar indicia, such as for example a measurement markup toolbar icon 30 and a patient demographics toolbar icon 32. Image processing module 60 displays the selected image entity 26 and the dynamic tag interface on the diagnostic interface 36 through the display driver 55. As shown in FIG. 2, patient demographics 28 associated with the displayed image entity 26 are displayed within the display area 22. It should be understood that this is only one exemplary embodiment and numerous other display arrangements will be apparent to those skilled in the art.

The patient demographic toolbar icon 32 (FIG. 2) allows the user 16 to control the display of patient demographics 28 using the mouse 12 from the user workstation 8. The patient demographics toolbar icon 32 may be dynamically generated based on the displayed image data. For example, the dynamic tag interface module 85 retrieves patient demographics 28 associated with the displayed image from the image processing module 60 and dynamically generates the patient demographics toolbar icon 32.

Optionally, the patient demographics toolbar icon 32 provides the user 16 with the ability to specify what patient demographics 28 to display within display area 22. For example, the user 16 can select a patient demographic 28 from a provided list (not shown). Optionally, the patient demographics toolbar icon 32 allows the user 16 to display groups of patient demographics 28, such as for example, a patient-related group, an image study-related group and a modality-related group. Alternatively, the patient demographic toolbar icon 32 can also allow the user 16 to not display any patient demographics 28 or group of patient demographics 28 within the display area 22 (i.e., to “hide” patient demographics 28).

The measurement markup toolbar icon 30 is used by user 16 to create an image markup 34, which is displayed on top of the image entity 26 by the dynamic tag interface module 85. The image markup 34 is used by the measurement markup module 75 to determine a corresponding measurement value 48. Optionally, the dynamic tag interface module 85 creates a markup dialogue box 38 containing the measurement value 48 and associated patient diagnosis information 58 within the display area 22 for the user 16 to review. A plurality of measurement markup toolbar icons 30 may be generated by dynamic tag interface module 85, where each measurement markup toolbar icon 30 corresponds to a specific image mark up and measurement value 48, such as for example the angle of a hip or angle of a knee. Each measurement markup toolbar icon 30 provides the user 16 with the ability to create a specific number and type of image markups 34, as will be explained further.

Display driver 55 is a conventional display screen driver implemented using commercially available hardware and software. As shown in FIG. 2, display driver 55 ensures that various image entities 26 are displayed in a proper format within the display area 22. Display driver 55 provides image data associated with the displayed image appropriately formatted so that the images are properly displayed on the diagnostic interface 36.

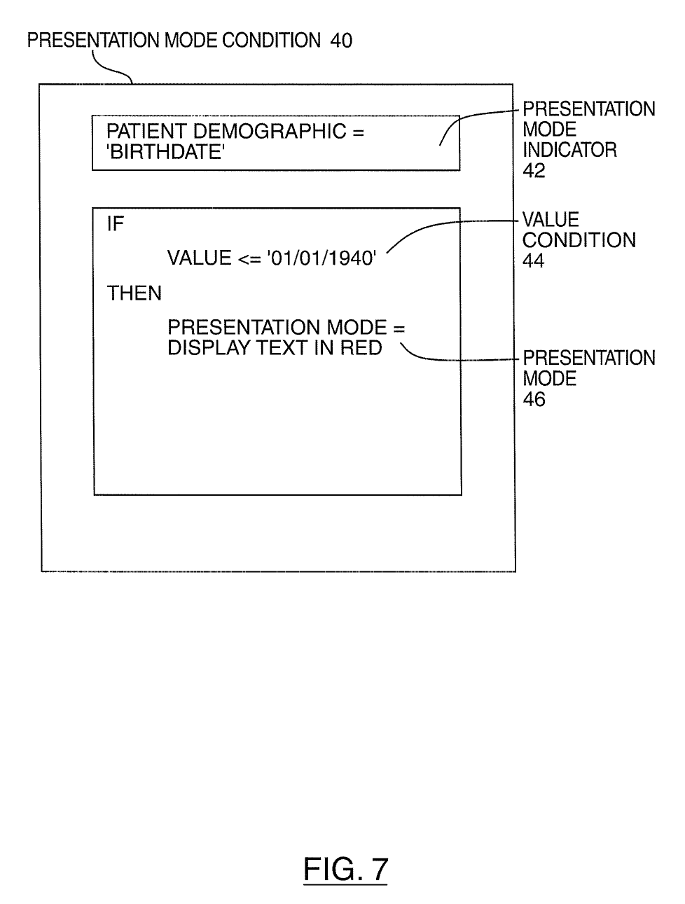

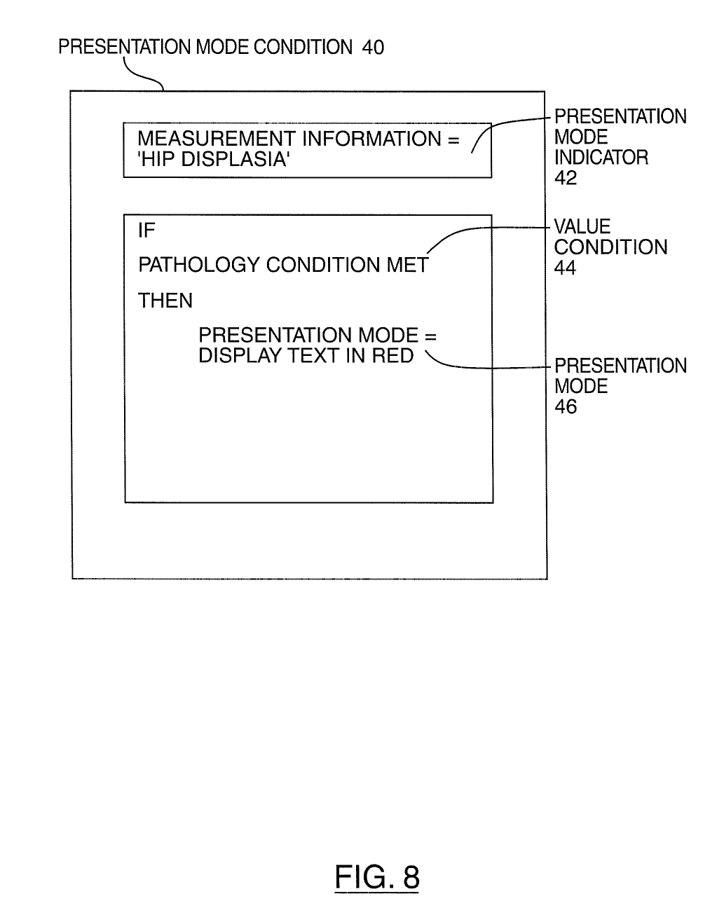

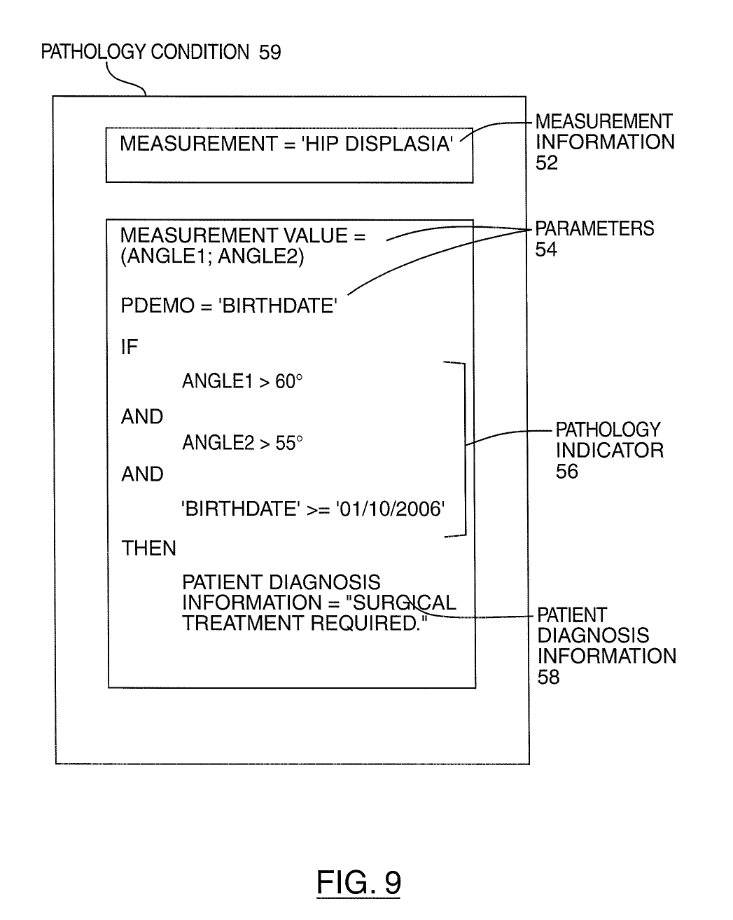

User preference database 90 stores the presentation mode conditions 40 associated with both patient demographics 28 and measurement value(s) 48 (FIGS. 7 and 8). The presentation mode conditions 40 determine when the presentation mode 46 of a patient demographic 28 or a measurement value 48 should be changed to a second presentation mode 46 and what the second presentation mode 46 should be. The user preference database 90 also contains a pathology library 95, which contains pathology conditions 59 (FIG. 9). The pathology conditions 59 determine when a calculated measurement value 48 and relevant patient demographics 28 indicate a specified pathology. The pathology condition 59 contains patient diagnosis information 58 relating to an indicated pathology.

Presentation mode module 70 is utilized by image processing module 60 to dynamically change the presentation mode 46 of patient demographics 28 from a first presentation mode to a second presentation mode 46. The presentation mode is changed if a presentation mode condition 40 (FIGS. 7 and 8) stored in the user preference database 90 is met. When the user 16 selects an image entity 26 from the non-diagnostic interface 20, image data including patient demographics 28 are provided to image processing module 60 through patient demographics module 65 and at least one patient demographic 28 is displayed within the display area 22. The at least one displayed patient demographic 28 is displayed in a first presentation, as stored in the user preference database 90.

Upon receiving the at least one displayed patient demographics 28, presentation mode module 70 queries the user preference database 90, through the image processing module 60, to receive all corresponding presentation mode conditions 40 associated with the displayed patient demographics 28 (FIG. 7). Presentation mode module 70 compares the value of the displayed patient demographic 28 with a relevant presentation mode condition 40 and if the condition is met, presentation mode module 70 signals to image processing module 60 to change the presentation mode 46 of the displayed patient demographics 28 to a second presentation mode 46 (as specified in the presentation mode condition 40).

An exemplary embodiment of a presentation mode condition 40 relating to patient demographics 28 is shown in FIG. 7. The presentation mode condition 40 contains a presentation mode indicator 42 that specifies a specific type of patient demographic 28 it is relevant to. Referring to FIG. 7, an example of a type of patient demographic 28 is the patient's birth date. The presentation mode condition 40 also contains a value condition 44, such as for example whether the patient is born before Jan. 1, 1940. In addition, the presentation mode condition 40 indicates a second presentation mode 46, for example displaying the birth date in red text. Highlighting the birth date in red text would signal to the user 16 that the patient is in an older age range and that the patient demographic 28 may be relevant in making a diagnosis.

Presentation mode module 70 also provides for the ability to dynamically change the presentation mode of a measurement value 48 determined by measurement markup module 75 Similarly, upon receiving the measurement value 48 from image processing module 60, presentation mode module 70 queries the user preference database 90 for all presentation mode conditions 40 associated with the measurement value 48. Presentation mode module 70 then compares the measurement value 48 to an associated presentation mode condition 40 to determine whether the presentation mode of the measurement value 48 should change to a second presentation mode 46. An exemplary embodiment of a presentation mode condition 40 relating to a measurement value 48 is shown in FIG. 8 and will be described in detail below. A measurement value 48 presentation mode condition 40 relates to a type of measurement and contains a value condition 44 and specifies a second presentation mode 46.

Measurement markup module 75 is utilized by image processing module 60 to determine the measurement value 48 (FIG. 2) associated with an image markup 34 created by the user 16 on a displayed image. After the user 16 has finished making the required image markups 34, image processing module 60 provides the image data, the image markup 34, and information regarding what measurement the specific image markup 34 represents (herein referred to as measurement information 52) to measurement markup module 75 in order to determine the corresponding measurement value 48. Finally, measurement markup module 75 provides the measurement value 48 to image processing module 60 for display on the diagnostic interface 36. The measurement value 48 is also utilized by pathology module 80 to determine whether the measurement value 48 indicates a specific pathology.

Pathology module 80 provides for the ability to indicate whether a measurement value 48 and relevant patient demographics 28 (FIG. 2) indicate a specified pathology. Pathology module 80 retrieves the measurement value 48, measurement information 52, and patient demographics 28 associated with the displayed image from image processing module 60. Upon receiving the measurement information 52, pathology module 80 queries the pathology library 95, stored in the user preference database 90, for all pathology conditions 59 (FIG. 9) associated with the measurement information 52.

An exemplary embodiment of a pathology condition 59 is shown in FIG. 9. The pathology condition 59 indicates what measurement information 52 the condition is relevant to, such as for example a hip displasia measurement value 48. The pathology condition 59 also indicates the required parameters 54, such as for example the measurement value 48 and relevant patient demographics 28. As shown in FIG. 9, the value of two angles and the patient's age are the required parameters 54. Next, pathology module 80 determines whether the received measurement value 48 and relevant patient demographics 28 meet a condition, namely a pathology indicator 56 (FIG. 9). If pathology module 80 determines that pathology indicator 56 is met, pathology module 80 provides the patient diagnosis information 58, contained in the pathology condition 59, to image processing module 60 for display on the diagnostic interface 36 for the user 16 to review.

It should be understood that the functionality of dynamic tag display system 10 is equally applicable to the display and arrangement of any image entity 26 within a prescribed display area 22. In addition it should be understood that the functionality of dynamic tag display system 10 is equally applicable to all patient demographics, including study and image level attributes, such as for example the patient's birth date and the image zoom ratio. More generally, it should be understood that the functionality of image processing module 60, patient demographics module 65, measurement markup module 75, presentation mode module 70, pathology module 80, and dynamic tag interface module 85 can be applied to any display system that is used to display image entities 26 to a user 16.

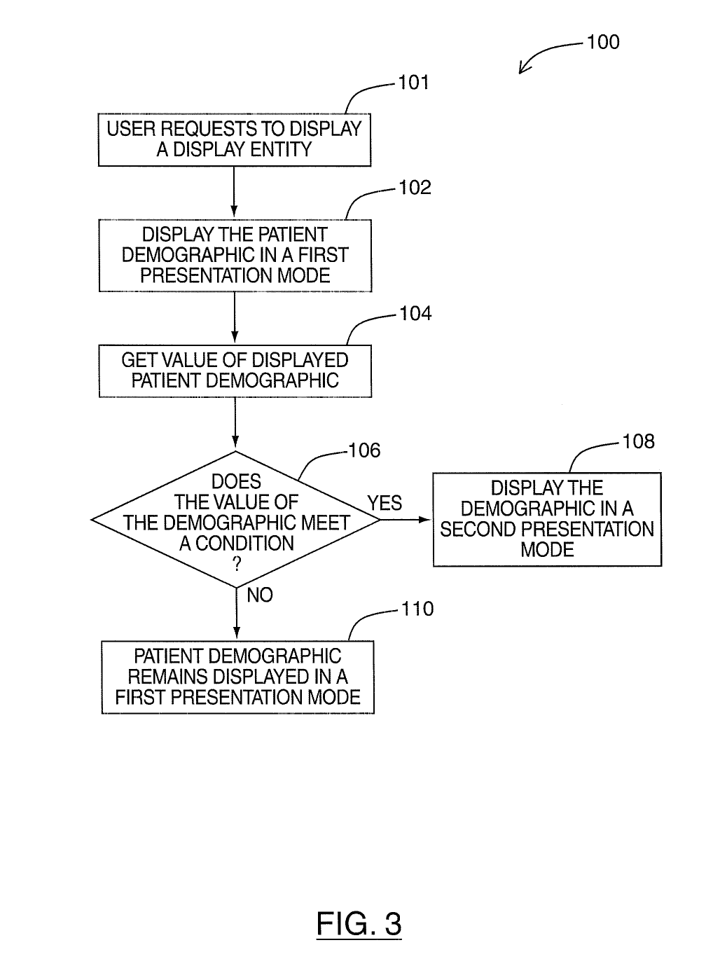

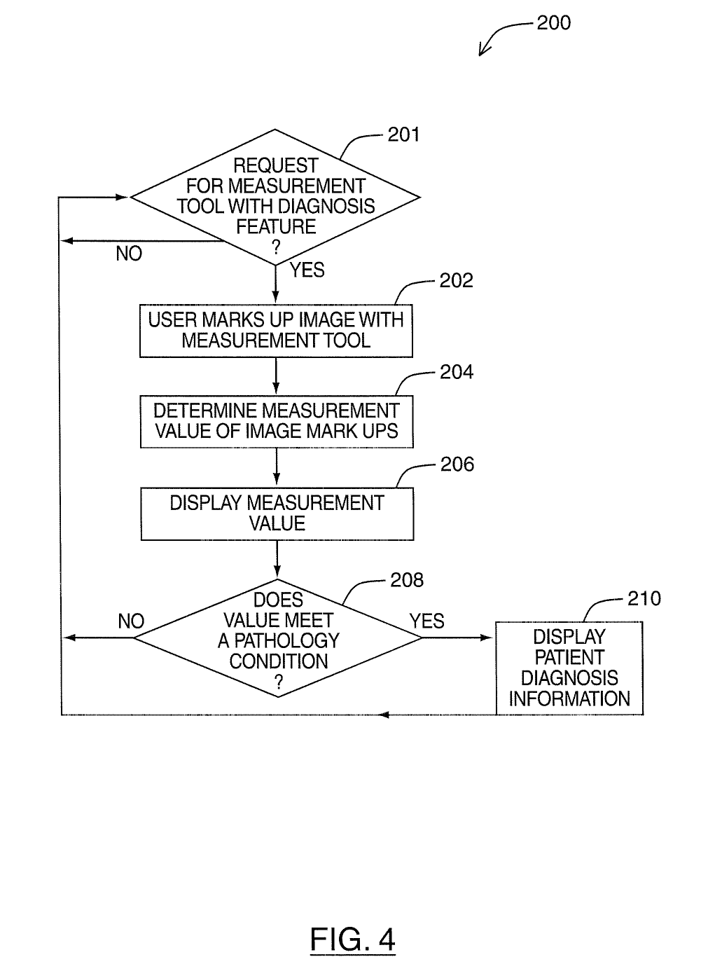

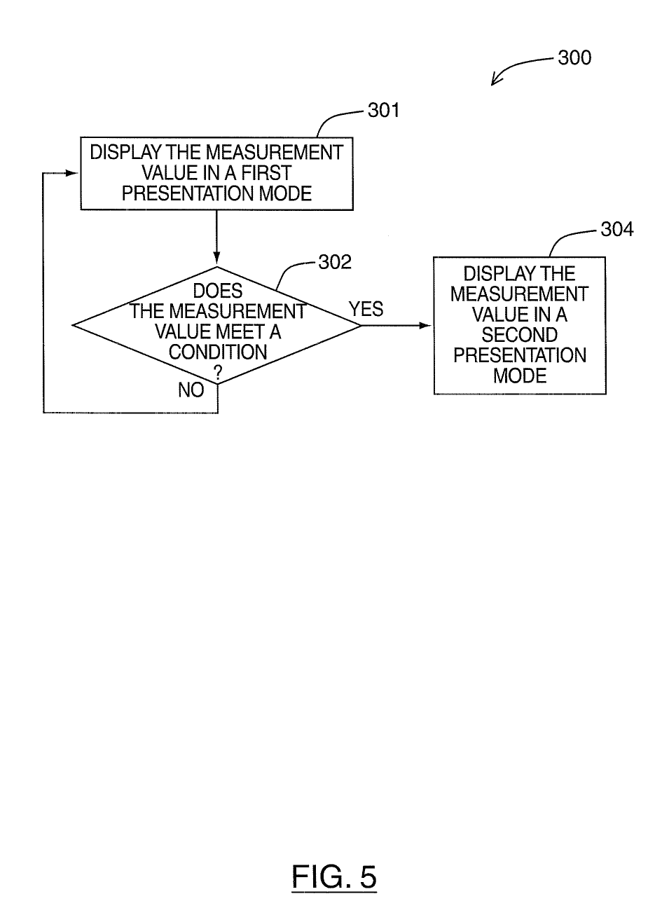

Referring now to FIGS. 1, 2, 3, 4 and 5 there is illustrated the basic operational steps 100, 200, and 300 of dynamic tag display system 10. Specifically FIG. 3 illustrates the basic operational steps 100 for altering the presentation mode 46 of a patient demographic 28. FIG. 4 illustrates the basic operational steps 200 for displaying patient diagnosis information 58. FIG. 5 illustrates the basic operational steps 300 for altering the presentation mode 46 of a measurement value 48. As will be understood, certain parts of the operational steps 100, 200 and 300 can be performed by the user 16, while other parts will be performed automatically by the dynamic tag display system 10.

Referring to FIG. 3 at step (101), the user 16 selects an image entity 26 from the non-diagnostic interface 20 using the keyboard 14 and/or mouse 12 from the user workstation 8 for display on the non-diagnostic interface 20. The image processing module 60 then requests the image data, including patient demographics 28, associated with the requested image entity 26 from the image server 4 through the patient demographics module 65. Image server 4 identifies the requested image data and retrieves it from image database 6 and sends it to patient demographics module 65 which provides it to the image processing module 60.

As explained earlier, the image data contains pixel data representing the displayed image entity 26 and patient demographics 28 associated with the image entity 26. Image processing module 60 displays the image entity 26 on the diagnostic interface 36 through the display driver 55. Dynamic tag interface module 85 generates a dynamic tag interface with a toolbar 24 containing dynamic tag indicia, including the measurement markup toolbar icon 30 and patient demographic toolbar icon 32 and which it provides to image processing module 60 for display within display area 22.

Referring to FIG. 3, at step (102), image processing module 60 displays at least one patient demographic 28 associated with the displayed image within the display area 22. As mentioned earlier, patient demographics 28 represent a set of textual attributes that describes the image, including without limitation such attributes such as patient-related information, image study-related information, modality-related information, image attributes and image characteristics calculated from image attributes (e.g. for example the zoom ratio).

Optionally, the user preference database 90 may store information pertaining to which at least one patient demographic 28 should be displayed, as configured by the user 16. The user preference database 90 stores what first presentation mode the at least one patient demographics 28 should be displayed in (not shown). As such, the image processing module 60 queries the user preference database 90 to determine what at least one patient demographics 28 to display and its corresponding first presentation mode. In addtion, which at least one patient demographics 28 is displayed may be dependent on the image data associated with the displayed image.

Image processing module 60 displays the patient demographics 28 in the first presentation mode within the display area 22 using the display driver 55. As shown in FIG. 2, more than one patient demographic 28 may be displayed within the display area 22. For example, the patient's name, age and sex may be displayed. In addition, modality-related patient demographics 28 such as image acquisition information may be displayed. As previously mentioned patient demographics also include image characteristics calculated from image attributes, such as for example the zoom ratio of the displayed image, which may also be displayed within the display area 22.

In another exemplary embodiment, the user 16 may indicate which patient demographics 28 to display using the patient demographic toolbar icon 32. As an example, the patient demographic toolbar icon 32 may reference a group of patient demographics 28 to display within the display area 22 (FIG. 2). The user 16 may use the mouse 12 to select a patient demographic toolbar icon 32 related to the group of patient demographics 28 to display. Referring to FIG. 2 as an example, the patient demographics 28 group may be a patient-related group, an image study-related group and a modality-related group, as configured by the user 16 and stored in the user preference database 90. Optionally, the user 16 can create a customized group of patient demographics 28, which would be stored in the user preference database 90. In addition, the groups of patient demographics 28 could be dependant on the image data associated with the displayed image.

In this embodiment, image processing module 60 polls the patient demographic toolbar icon 32 to determine which group of patient demographics 28 the user 16 has selected using the mouse 12 from the user workstation 8. Image processing module 60 would retrieve the selected patient demographics 28 contained in the displayed image data and display them within the display area 22 the user 16 may optionally use the patient demographic toolbar icon 32 to hide the display of a patient demographics 28 or a group of patient demographics 28.

Referring back to FIG. 3, at step (104), assuming at least one patient demographics 28 is being displayed, image processing module 60 retrieves the type of the at least one patient demographics 28. For example, one type of patient demographic is the patient's birth date. Image processing module 60 provides the type to presentation mode module 70 to determine whether the at least one displayed patient demographic 28 should be displayed in a second presentation mode 46.

Upon receiving the type of the at least one displayed patient demographic 28 at step (106) presentation mode module 70 queries the user preference database 90, through the image processing module 60, to receive all presentation mode conditions 40 associated with the displayed patient demographics 28. An exemplary embodiment of a presentation mode condition 40 is shown in FIG. 7. In order to determine which presentation mode conditions 40 are associated with the displayed patient demographics 28, reference is made to a patient demographic 28 indicator which links the presentation mode condition 40 with a specific type of patient demographic 28.

The example provided in FIG. 7 is a presentation mode condition 40 associated with the patient demographic 28 “birthdate”, namely the patient's birth date, as specified by the presentation mode indicator 42. It should be understood that one type of patient demographic 28 may have a plurality of associated presentation mode conditions 40. Moreover, a displayed patient demographic 28 may not have any associated presentation mode condition 40. In that case, the user preference database 90 may indicate the same to the presentation mode module 70 and the displayed patient demographic 28 remains in the first presentation mode. The presentation mode condition 40 could be generated by the user 16 or a professional service person and stored in the user preference database 90.

Upon receiving all presentation mode conditions 40 associated with the type of the provided patient demographic 28, the presentation mode module 70 compares the value of the patient demographic 28 to the value condition 44 contained in the presentation mode condition 40 (FIG. 7) to determine whether the presentation mode 46 should be altered. Altering the presentation mode depending on the patient demographic 28 value would aid the user 16 in making a patient diagnosis. For example, a patient's age could be highlighted if the patient is older or younger, to indicate to the user 16 that age may be a relevant a patient demographic to consider when making a diagnosis.

Another example involves patient demographics 28 calculated using image attributes, such as the zoom ratio of the displayed image. For example, if the zoom ratio becomes too small, the presentation mode 46 could change to highlight to the user 16 that some image features may be missing from the diagnostic interface 36.

Referring back to FIG. 3, at step (108), if the presentation mode module 70 determines that the presentation mode value condition 44 was met then the presentation mode module 70 would provide the second presentation mode 46 to the image processing module 60 to dynamically alter the display of the patient demographics 28 on the diagnostic interface 36 through the display driver 55.

Referring to FIG. 7, if the value of the patient demographic 28 “birthdate” indicates that the patient is older, that is born before Jan. 1, 1940, then presentation mode module 70 signals to image processing module 60 to alter the presentation mode 46 of the patient demographics 28 “birthdate” and provides a second presentation mode 46 as defined in the presentation mode condition 40, namely displaying the patient's birth date in red. If the presentation mode value condition 44 has not been met then the image processing module 60 would not alter the presentation mode of the displayed patient demographics 28.

Finally, referring to FIG. 3, if the if the presentation mode module 70 determines that the presentation mode value condition 44 was not met then at step (110) the displayed patient demographic(s) 28 would remain in a first presentation state.

Referring now to FIG. 4 the basic operational steps 200 for displaying patient diagnosis information 58 is illustrated. At step (201), image processing module 60 polls measurement markup toolbar icon 30 to determine whether the user 16 has requested to create an image markup 34 with dynamic tag functionality using the mouse 12 from the user workstation 8 (e.g. by clicking on the measurement markup toolbar icon 30). Optionally there may be a plurality of measurement markup toolbar icons 30, each corresponding to a specific measurement markup. For example, one measurement markup toolbar icon 30 may be related to a measurement markup for a hip to assist the user 16 in making a hip displaysia diagnosis. Another example of a measurement markup toolbar icon 30 may be related to a measurement markup for a knee to assist the user 16 in making a knee related diagnosis.

Referring back to FIG. 4, at step (202), the user 16 creates an image markup 34 by marking up the image using the mouse 12 of the user workstation 8, such as for example, selecting a required number of points on the image where a markup line would be created and connect the points. Upon making a markup, the dynamic tag interface module 85 will create a corresponding image markup 34 for display within the display area 22 on top of the displayed image, as shown in FIG. 2. It will be apparent to those skilled in the art how the dynamic tag interface creates an image markup 34 on top of the displayed image entity 26.

As previously mentioned each measurement markup toolbar icon 30 corresponds to a specific measurement markup, herein referred to as measurement information 52 (FIG. 9). Every specific measurement may require a certain number and type of markups to be made in order for the dynamic tag display system 10 to determine a corresponding measurement value 48. What type of mark ups and how many are required will be stored in the user preference database 90 as configured by the user 16.

As such, after the user 16 selects a measurement markup toolbar icon 30 using the mouse 12 from the user work station, the image processing module 60 will utilize the user preference database 90 to determine what mark ups the user 16 is required to make. For example, if the measurement markup toolbar icon 30 corresponded to a hip measurement markup for a hip displasia diagnosis, the user 16 would be required to make three line markups, where the angles between these lines would be used to determine what diagnosis should be given.

Optionally, the user 16 would only be allowed to make the necessary markups in a specified order to assist the user 16 in determining which mark ups are required. In addition, a dialogue box may be created by dynamic tag interface module 85 indicating the required markups to the user 16, as provided by image processing module 60.

When the user 16 has finished making the image markup 34, referring to FIG. 4, at step (204) dynamic tag display system 10 will determine the corresponding measurement value 48 of the image markup 34 using the measurement markup module 75. The image processing module 60 retrieves the user 16 created image markup 34 and image data relating to the displayed image. The image processing module 60 queries the user preference database 90 for measurement information 52 associated with the image markup 34. The image processing module 60 provides the measurement information 52, image data and the image markup 34 to the measurement markup module 75 to determine the corresponding measurement value 48.

For example, if the markup is a hip displasia markup then the image processing module 60 provides measurement markup module 75 with the three line image markup 34, the measurement information 52 (i.e., that the markup relates to hip displasia) and image data, in order to determine the angles between the three line markups. Those skilled in the art will understand how the dynamic tag system determines the specific measurement value 48 using the image markup 34, displayed image data and information stored in the user preference database 90. Finally, measurement markup module 75 provides the determined measurement value 48 to the image processing module 60.

Referring back to FIG. 4, at step (206) image processing module 60 displays the measurement value 48 on the diagnostic interface 36 within the display area 22 using the display driver 55. Optionally, the image processing module 60 provides dynamic tag interface module 85 with the measurement value 48. Dynamic tag interface module 85 creates a markup dialogue box 38 for displaying the measurement value 48 to the user 16 within the display area 22 to assist the user 16 in making a diagnosis. For example, if the measurement value 48 corresponds to the hip angles relevant to hip displasia, then the value of those angles will be provided to the user 16 to assist them in making a hip displasia diagnosis, as shown in FIG. 2. The markup dialogue box 38 is provided to image processing module 60 for display on the diagnostic interface 36 through the display driver 55.

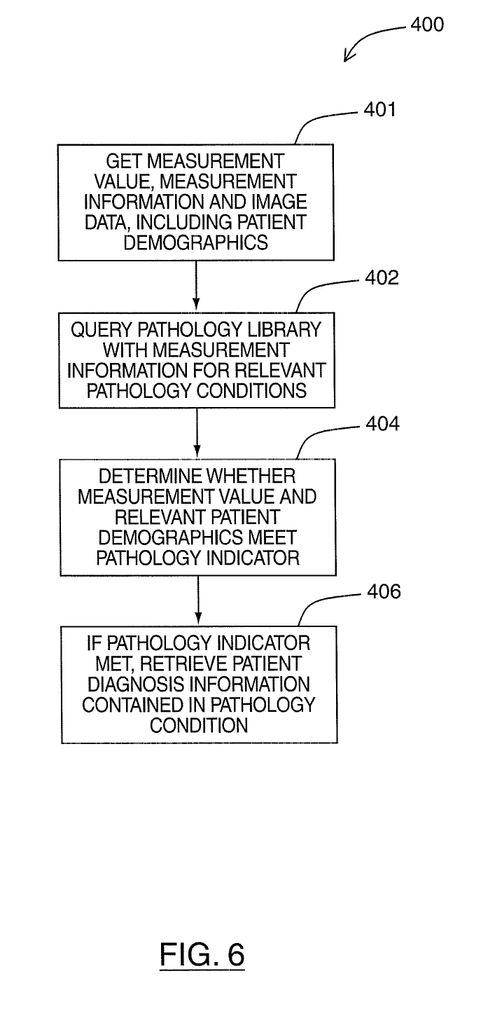

Referring back to FIG. 4, at step (208) pathology module 80 determines whether the measurement value 48 and patient demographics 28 indicate a specified pathology stored in the pathology library 95 within the user preference database 90. Now referring to FIG. 6 there is illustrated the basic operational steps (400) for determining whether the measurement value 48 indicates a specified pathology. At step (401) image processing module 60 provides the measurement value 48, measurement information 52 (i.e. information indicating what the measurement value 48 represents) and the displayed image data, including patient demographics 28, to the pathology module 80.

As previously, mentioned the user preference database 90 optionally contains a pathology library 95 of pathology conditions 59. Pathology conditions 59 may be configured by the user 16 and stored within the pathology library 95. These pathology conditions 59 are associated with specific measurement information 52 relating to the measurement value 48 and the measurement markup toolbar icons 30. An exemplary embodiment of a pathology condition 59 is illustrated in FIG. 9. In this example, the pathology condition 59 is related to ‘hip displasia’ measurements, as indicated by the measurement information 52.

Referring to FIG. 6, at step (402) pathology module 80, through the image processing module 60, queries the pathology library 95 with measurement information 52 for all relevant pathology conditions 59. For example, the pathology module 80 would query the pathology library 95 for all for pathology conditions 59 that are relevant to hip displasia. Referring back to FIG. 9, the exemplary pathology condition 59 illustrated is relevant to a hip displasia diagnosis. As such, the pathology library 95 returns the pathology condition 59 illustrated in FIG. 9.

It should be understood that a plurality of pathology conditions 59 could be relevant to a single measurement and all relevant pathology conditions 59 would be returned to the pathology module 80 to determine whether a specified pathology is indicated by the measurement value 48. As previously mentioned, the user 16 can configure the pathology condition(s) 59 stored in the pathology library 95, contained in user preference database 90. The pathology condition 59 information can optionally be based on commercially available medical books that list various measurement ranges and what pathology these measurement ranges indicate.

Referring back to FIG. 6, at step (404) the pathology module 80 receives all relevant pathology conditions 59 from the user preference database 90 and determines whether the measurement value 48 and relevant patient demographics 28 indicate a pathology, i.e. meets the pathology indicator 56 condition as shown in FIG. 9. The pathology condition 59 could specify what measurement value(s) 48 and patient demographics 28 are used to determine whether a pathology is indicated. Referring back to FIG. 9 as an example, in order to make a hip displasia diagnosis, the relevant measurement values 48 are the two angles determined at step (204) (FIG. 4) and the relevant patient demographic 28 is the patient's birth date. The pathology module 80 uses that information to determine whether the pathology indicator 56 is met. For example, if the patient is a new born (in this example, born after Jan. 10, 2006) and the first angle and a second angle (i.e.: the calculated measurement value 48 associated with hip displasia) meet a stipulated condition (such as for example the pathology indicator 56 in FIG. 9) then the pathology indicator 56 is met. It should be understood that a pathology indicator 56 can be configured by the user or a professional service person based on known measurement values and conditions.

Referring back to FIG. 6, if the pathology indicator 56 condition is met then at step (406) then the pathology module 80 retrieves the patient diagnosis information 58 contained within the pathology condition 59 and provides it to the image processing module 60. Referring back to FIG. 9 as an example, the patient diagnosis information 58 “Surgical Treatment Required” will be retrieved from the pathology condition 59 and provided to the image processing module 60 for display on the diagnostic interface 36.

It should be understood the patient diagnosis information 58 could be presented in numerous ways and that the presentation illustrated in FIG. 9 is only one exemplary embodiment. Moreover, as previously mentioned a given measurement value 48 may have a plurality of associated pathology conditions 59 and as such it is contemplated that the measurement value 48 may have a plurality of associated patient diagnosis information(s) 58 that can all be provided to image processing module 60 by the pathology module 80 for display. Alternatively, the dynamic tag display system 10 could be user 16 configured such that only one associated patient diagnosis information 58 per measurement is displayed.

Finally, referring to FIG. 4, at step (210), the image processing module 60 displays the patient diagnosis information 58 provided by the pathology module 80 within the display area 22 using the display driver 55. Optionally, the patient diagnosis information 58 could be displayed within the markup dialogue box 38 created by the dynamic tag interface module 85 as shown in FIG. 2. It should be understood the patient diagnosis information 58 could be presented to the user 16 in numerous ways and FIG. 2 is only one exemplary embodiment.

In an optional embodiment, the presentation mode of the measurement value 48 displayed at step (206) (FIG. 4) can dynamically change from a first presentation mode to a second presentation mode if a pathology stored in the pathology library 95 is indicated. This would highlight to the user 16 that the measurement value 48 associated with the indicated pathology is relevant in making a diagnosis. The dynamically changing presentation mode 46 of the measurement value 48 is analogous to the dynamically changing presentation mode 46 of patient demographics 28, as described in steps (102) to (108) in FIG. 3.

Referring now to FIG. 5, there is illustrated the basic operational steps 300 for dynamically displaying the measurement value 48. As previously indicated the dynamic tag display system 10 displays the measurement value 48 at step (206) (FIG. 4). Referring to FIG. 5, optionally, at step (301) the measurement value 48 may be displayed in a first presentation mode. The image processing module 60 queries the user preference database 90 with measurement information 52 associated with the measurement value 48 to determine first presentation mode for that measurement value 48.

Optionally, the first presentation mode could be a default mode for all measurement values 48, regardless of the associated measurement information 52, as configured by the user 16 and stored on the user preference database 90. Next, image processing module 60 displays the measurement value 48 in the first presentation mode within the display area 22 using the display driver 55. Optionally the measurement value 48 may be displayed in a markup dialogue box 38 created by the dynamic tag interface module 85 It is understood how a markup dialogue box displays the measurement value 48.

Referring again to FIG. 5, at step (302), the image processing module 60 determines whether the measurement value 48 meets a condition indicating that its presentation mode 46 will dynamically change. As illustrated in FIG. 8 a measurement value 48 optionally has a presentation mode condition 40, analogous to the presentation mode conditions 40 associated with patient demographics 28 (FIG. 7). This presentation mode condition 40 indicates when the presentation mode should change and what a second presentation mode 46 is.

Referring to FIG. 8 as an example, the presentation mode 46 for a measurement value 48 could change if at step (208) (FIG. 4) it is determined that a pathology is indicated, i.e.: pathology condition 59 stored in the user preference database 90 is met. As previously mentioned, at step (208) the pathology module 80 determines whether a pathology is indicated and the result of the determination (i.e., the pathology result) is provided to the image processing module 60. The image processing module 60 provides the pathology result, the measurement value 48 and associated measurement information 52 to the presentation mode module 70 to determine whether the presentation mode 46 should be altered.

Next, the presentation mode module 70 queries the user preference database 90 for the presentation mode condition 40 (FIG. 8) relevant to the measurement information 52. For example if the measurement value 48 is associated with ‘Hip Displasia’ the measurement information 52 indicates the same and the presentation mode condition 40 illustrated in FIG. 8 would be returned. The presentation mode module 70 uses the provided pathology result to determine whether the presentation mode indicator 42 is met.

Referring to FIG. 5, at step (304), if the presentation mode indicator 42 is met, then the presentation mode module 70 provides the image processing module 60 with a second presentation mode 46 associated with the measurement value 48. The second presentation mode 46 is optionally stored in the presentation mode condition 40. Image processing module 60 displays the measurement value 48 in the second presentation mode 46 within the display area 22 using the display driver 55. In this example the measurement value 48 associated with ‘Hip Displasia’ is displayed in red text, as indicated by the presentation mode 46 in FIG. 8.

While the various exemplary embodiments of the dynamic tag display system 10 have been described in the context of medical image management in order to provide an application-specific illustration, it should be understood that dynamic tag display system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A system for dynamically changing the presentation of at least one patient demographic by changing from a first presentation mode to a second presentation mode for that at least one patient demographic, said system comprising:
a. a memory for storing the at least one patient demographic, a first presentation state, a second presentation state and a condition;
b. a processor coupled to the memory, said processor configured for:
i. displaying the at least one patient demographic in the first presentation mode;
ii. determining if the displayed at least one patient demographic meets a condition; and
iii. If (ii) is true, then changing from the first presentation mode to the second presentation mode for that at least one patient demographic.

2. The system of claim 1, wherein the processor is further configured for displaying the at least one patient demographic as selected by a user.

3. The system of claim 1, wherein the processor is further configured for displaying the at least one patient demographic as selected from a non-exhaustive group consisting of: a birth date, a zoom ratio, an acquisition information, an image attribute, a image study attribute, a display attribute, a modality attribute, a name, and a sex.

4. The system of claim 1, wherein the processor is further configured for displaying the first and second presentation modes of the at least one patient demographic in a different color.

5. The system of claim 1, wherein the processor is further configured for displaying the at least one patient demographic when at least one group of patient demographics is selected.

6. The system of claim 5, wherein the processor is further configured for displaying at least one group of patient demographics that is patient related.

7. The system of claim 5, wherein the processor is further configured for displaying at least one group of patient demographics that is study related.

8. The system of claim 5, wherein the processor is further configured for displaying at least one group of patient demographics that is modality related.

9. The system of claim 5, wherein the processor is further configured for displaying at least one group of patient demographics that is customized in a user configuration.

10. A system for dynamically indicating a measurement value and associated patient diagnosis information within an image, said system comprising:
a. a memory for storing image data associated with the image, patient diagnosis information and a condition;
b. a processor coupled to the memory, said processor configured for:
i. creating an image markup by marking up the image using a measurement tool;
ii. determining a measurement value for the image markup;
iii. displaying the measurement value determined in (ii);
iv. determining whether the measurement value meets a condition indicating a pathology; and
v. If (iv) is true, then displaying the patient diagnosis information associated with the pathology indicated in (iv).

11. The system of claim 10, also for dynamically changing the presentation mode of the measurement value by changing from a first presentation mode to a second presentation mode for that measurement value, said system further comprising:
a. a memory for storing a first presentation state, a second presentation state and a condition.
b. a processor coupled to the memory, said processor configured for:
i. displaying the measurement value in the first presentation mode;
ii. determining if the displayed measurement value meets a condition; and
iii. if (ii) is true, then changing from the first presentation mode to the second presentation mode for that measurement value.

12. The system of claim 11, wherein the processor is further configured for displaying the first and second presentation modes of the measurement value in different colors.

13. A method for dynamically changing the presentation of at least one patient demographic by changing from a first presentation mode to a second presentation mode for that at least one patient demographic, said method comprising:
a. displaying the at least one patient demographic in the first presentation mode;
b. determining if the displayed at least one patient demographic meets a condition; and
c. If (b) is true, then changing from the first presentation mode to the second presentation mode for that at least one patient demographic.

14. The method of claim 13, wherein the at least one patient demographic to display is selected by a user.

15. The method of claim 13, wherein the at least one patient demographic is selected from a non-exhaustive group consisting of: a birth date, a zoom ratio, an acquisition information, an image attribute, a display attribute, a image study level attribute, a modality attribute, a name, and a sex.

16. The method of claim 13, wherein the first and second presentation modes display the at least one patient demographic in a different color.

17. The method of claim 12, wherein the at least one patient demographic is displayed when at least one group of patient demographics is selected.

18. The method of claim 17, wherein at least one group of patient demographics is patient related.

19. The method of claim 17, wherein at least one group of patient demographics is study related.

20. The method of claim 17, wherein at least one group of patient demographics is modality related.

21. The method of claim 17, wherein at least one group of patient demographics is customized in a user configuration.

22. A computer readable medium upon which a plurality of instructions are stored, the instructions for performing the steps of the method as claimed in claim 13.

23. A method for dynamically indicating a measurement value and associated patient diagnosis information within an image, said method comprising:
a. creating an image markup by marking up the image using a measurement tool;
b determining a measurement value for the image markup;
c. displaying the measurement value determined in (b);
d. determining whether the measurement value meets a condition indicating a pathology; and
e. If (d) is true, then displaying the patient diagnosis information associated with the pathology indicated in (d).

24. The method of claim 23, also for dynamically changing the presentation mode of the measurement value by changing from a first presentation mode to a second presentation mode for that measurement value, further comprising:
a. displaying the measurement value in the first presentation mode;
b. determining if the displayed measurement value meets a condition;
and
c. if (b) is true, then changing from the first presentation mode to the second presentation mode for that measurement value.

25. The method of claim 24, wherein the first and second presentation modes display the measurement value in different colors.

26. A computer readable medium upon which a plurality of instructions are stored, the instructions for performing the steps of the method as claimed in claim 23.
